(19) United States
(12) Patent Application Publication
(10) Pub. No.: US 2023/0351828 A1
(43) Pub. Date: Nov. 2, 2023

(54) Smart Storage Container

(71) Applicant: OP Storage Partners LLC, Darien, CT (US)

(72) Inventors: Greg Easley, New Canaan, CT (US); Aike Mueller, Amsterdam (NL)

(21) Appl. No.: 18/141,742

(22) Filed: May 1, 2023

Related U.S. Application Data
(60) Provisional application No. 63/336,886, filed on Apr. 29, 2022.

(51) Int. Cl. G07C 9/00

(52) U.S. Cl. CPC G07C 9/00912; G07C 2009/00769; G07C 2009/00841; G07C 2009/00206

(57) ABSTRACT

An elevated smart storage system having a smart lock system and that is formed by a molded enclosure secured to a steel frame structure with support legs. The smart storage system may include a movable door that may further be securely locked by the smart lock system. The smart lock system may be controlled via a mobile or other hand-held device to selectively lock and/or unlock the door. The smart lock system may be an integrated internet of things smart lock that is controllable through Bluetooth® low energy, near field communication or Wi-Fi communication from a mobile or hand-held device. An application on the mobile or hand-held device may be used to provide a user interface and control of the smart lock system.

### CROSS-REFERENCE TO RELATED APPLICATION

This application claims priority to and incorporates by reference in its entirety U.S. Provisional patent application No. 63/336,886, filed on Apr. 29, 2022.

### TECHNICAL FIELD

This disclosure relates to the field of storage containers and lockers. The disclosure particularly relates to a novel smart storage container or locker for use in many locations, such as apartment complex garages, home garages, parking structures, and the like, and is especially designed to monetize the unused space in such locations.

### BACKGROUND

It is known that multi-family residential development is booming. Multi-unit apartment complexes are continuously being built in nearly every major city in the U.S. The apartments themselves, however, are getting smaller and more expensive. As a result, storage of personal belongings is becoming a greater problem that keeps getting worse with these smaller and smaller apartments. Additionally, there is presently an outdoor sports/fitness boom, which creates additional demand for storage of the equipment used with those sports. This creates even further pressure on an already shrinking available storage space environment.

Creating new storage space in an existing apartment via a remodel or retrofit is difficult and quite costly. And the use of a remote self-storage unit to store belongings is very inconvenient and rather expensive. These and other known problems are observed in not only U.S. cities, but in numerous cities around the world.

Accordingly, there is a need for a way to utilize and potentially monetize storage space within apartment complex garages and other parking structures. The smart storage container of the present disclosure overcomes the above-mentioned and other known problems by providing a convenient, secure, smart storage option without the need to remodel or retrofit, while simultaneously creating additional revenue for the apartment building or parking structure, if desired.

### SUMMARY

This Summary introduces a selection of concepts relating to this technology in a simplified form as a prelude to the Detailed Description that follows. This Summary is not intended to identify key or essential features.

In some aspects, a smart storage container is disclosed. The smart storage container may be an elevated storage system formed by a rotomolded enclosure that is secured to a steel frame structure, which is mounted to support legs. In an alternative aspect, the enclosure and steel frame structure may be mounted to a wall or other support surface to eliminate the need for support legs. In some examples, the enclosure may be formed into numerous possible sizes and shapes and may provide numerous possible storage capacities. In an exemplary aspect, the enclosure may be formed to provide around 60 cubic feet of storage. Of course, other shapes and sizes of the enclosure are possible to provide greater or lesser volume of storage capacity.

In an aspect, the enclosure may include a movable door that may further be securely locked by a smart lock system. The smart lock system may be controlled via a mobile or other hand-held device to selectively lock and/or unlock the door. In some examples, the smart lock system may be an integrated internet of things (IoT) smart lock that is controllable through Bluetooth® low energy (BLE), near field communication (NFC) or Wi-Fi communication from a mobile or hand-held device. An application on the mobile or hand-held device may be used to provide a user interface and control of the smart lock system.

The disclosed smart storage container may be used to contain numerous items that typically require storage, including items such as golf clubs, skis, snowboard, boots, surfboard, wetsuits, skateboard, scooter, camping equipment, helmets, car roof rack and attachments, child seat, outdoor toys, stroller, bulk household products from wholesale stores, out-of-season clothing and home décor, power tools, shop vacs, paint, and cleaning supplies, to name a few items.

These and other features, advantages, and objects of the present disclosure will be further understood and appreciated by those skilled in the art by reference to the following specification, claims, and appended drawings, where various embodiments of the design illustrate how concepts of this disclosure may be used.

### BRIEF DESCRIPTION OF THE DRAWINGS

The present invention is illustrated by way of example and not limited in the accompanying figures in which like reference numerals indicate similar elements and in which:

FIG. 1 is an exemplary smart storage container of the disclosure.

FIG. 2 is an exemplary smart storage container of the disclosure with the door in an open position and an automobile parked underneath.

FIG. 3 are exemplary images of an exemplary mobile device application for use with the smart storage container.

FIG. 4 is another view of an exemplary smart storage container of the disclosure with the door in an open position and an automobile parked underneath.

FIG. 5 depicts multiple exemplary smart storage containers located within a parking structure.

FIG. 6 is an alternative embodiment of an exemplary smart storage container of the disclosure.

FIG. 7 is an alternative embodiment of an exemplary smart storage container of the disclosure mounted to a wall and with the door in an open position.

FIG. 8 is another view of the exemplary smart storage container of FIG. 7.

FIG. 9 is another view of the exemplary smart storage container of FIG. 7.

FIG. 10A is an exemplary frame for use with the exemplary smart storage container.

FIG. 10B is an exemplary frame for use with the exemplary smart storage container.

FIG. 11 is an exemplary frame for use with the exemplary smart storage container.

FIG. 12 is an exemplary enclosure that is part of the exemplary smart storage container.

FIG. 13 is another view of an exemplary enclosure that is part of the exemplary smart storage container.

FIG. 14 is another view of an exemplary enclosure that is part of the exemplary smart storage container.

FIG. 15 is another view of an exemplary enclosure that is part of the exemplary smart storage container.

FIG. 16 is an exemplary door that is part of the exemplary smart storage container.

FIG. 17 is another view of an exemplary door that is part of the exemplary smart storage container.

FIG. 18 is another view of an exemplary door that is part of the exemplary smart storage container.

FIG. 19 is another view of an exemplary door that is part of the exemplary smart storage container.

FIG. 20 is another view of an exemplary door that is part of the exemplary smart storage container and that depicts various components of the exemplary smart storage container.

Further, it is to be understood that the drawings may represent the scale of different components of one single embodiment; however, the disclosed embodiments are not limited to that particular scale.

### DETAILED DESCRIPTION

In the following description of the various embodiments, reference is made to the accompanying drawings and which form a part hereof, and in which is shown by way of illustration various embodiments in which features described herein may be practiced. It is to be understood that other embodiments may be utilized and structural and functional modifications may be made without departing from the scope described herein. Various features are capable of other embodiments and of being practiced or being carried out in various different ways.

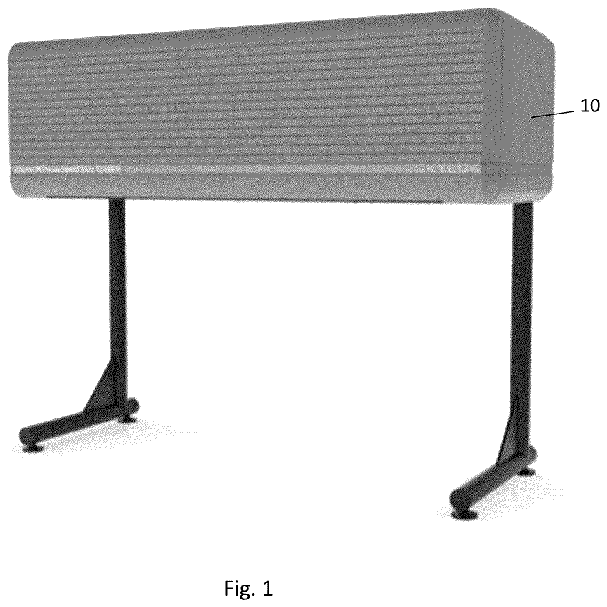

Referring to FIG. 1, there is disclosed an exemplary smart storage container 10 of the invention. The smart storage container 10 may be an elevated storage system consisting of an elevated enclosure that is secured to a frame structure having support legs. The container may be made through a rotomolding process to create a lightweight, durable, wear and weather resistant enclosure for containing and properly storing all types of personal belongings. The container may include a rotatable door that extends downwardly from a top edge of the enclosure and that will naturally be in a closed position when the door is not lifted up to the open position.

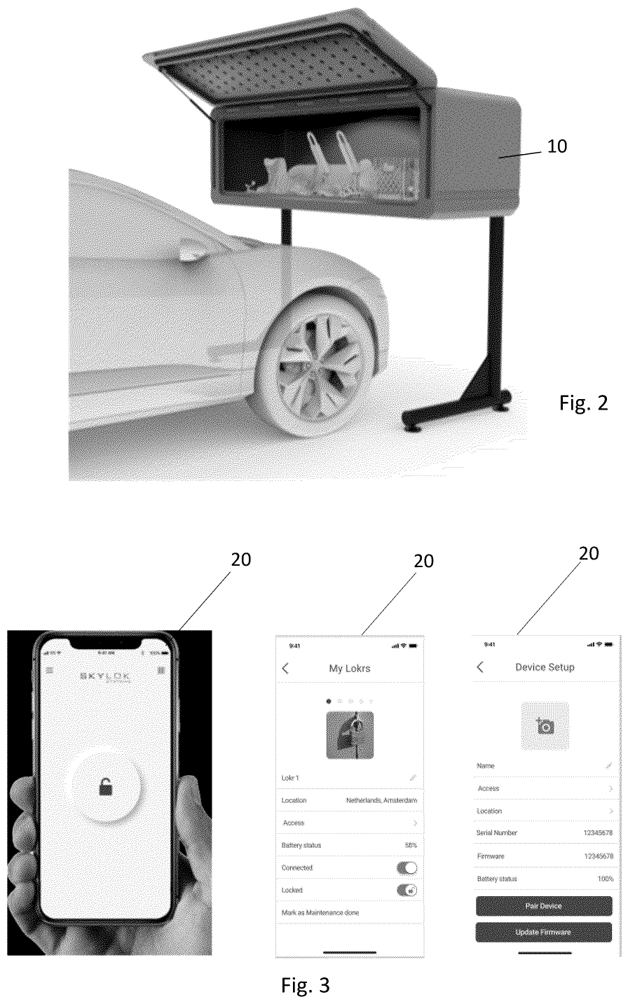

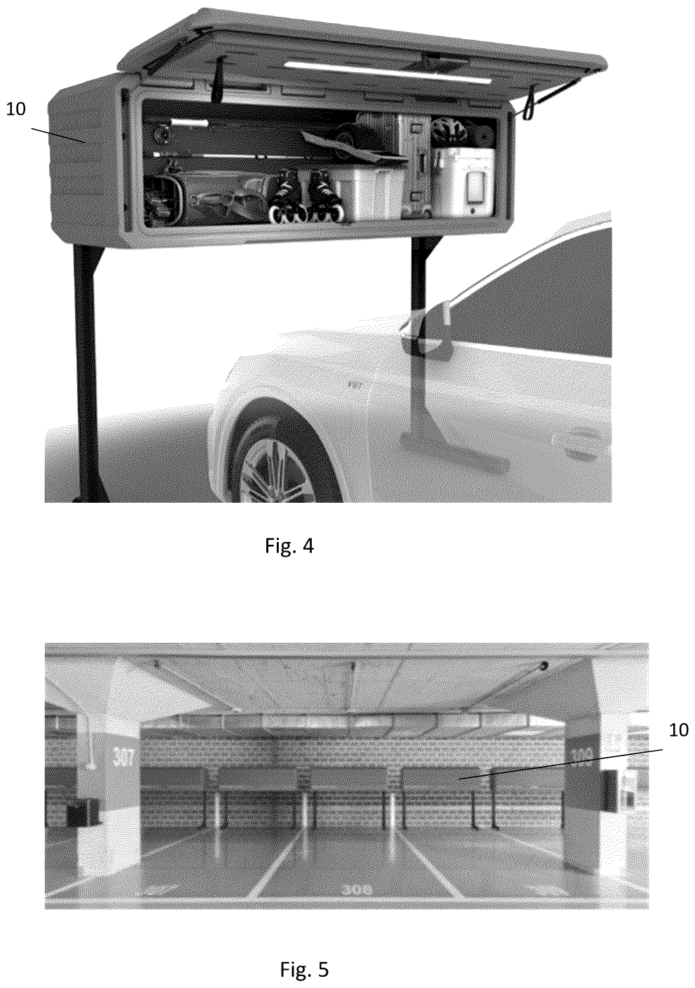

Referring to FIGS. 2 and 4, the exemplary storage container 10 is depicted with the door in an open position. In the open position, personal belongings are accessible or additional belongings can be placed within the interior of the enclosure. A hinge may be used to connect the door to the body of the enclosure, and one or more piston-type actuator arms or gas struts may be positioned on opposite end walls of the enclosure to assist in keeping the door in an open position. LED lights may be used within and outside of the enclosure to illuminate the contents within the enclosure and to illuminate the surrounding area. Pull straps may also be added to the door to assist the user in moving the door to the closed position. Support legs hold and support the storage container and elevate the container above the floor. In one aspect, the support legs may define an “L” shape that permits a vehicle to park underneath it and thus take up less space in the garage or parking space. The “L” shaped legs are uniquely designed to support and position the container and to accommodate the potential weight of items that may be stored in or on the container. The elevated nature of the container also allows the container to be located in a location in a parking area that is otherwise unused, thereby improving the space efficiency within the parking area.

Referring to FIG. 3, the storage container 10 may be controlled by an application 20 on a mobile or hand-held device. Exemplary images of the application 20 are depicted in FIG. 3. The application on the mobile or hand-held device may provide a user interface to allow the user to control the locking and unlocking of the storage container. The application may control other features installed in or on the storage container 10, as explained below. The application may further communicate with a back-end application or network that will provide additional features and functionality to the application and to the storage container.

Referring to FIG. 5, numerous smart storage containers 10 may be located within a parking structure in front of each parking stall. Because of the mobility of each container, the container may be positioned at any desired location relative to the parking stall. Each storage container may be independently programmed and independently controlled through a mobile application. The owner of the parking structure may be able to monetize the use of one or more of the smart storage containers.

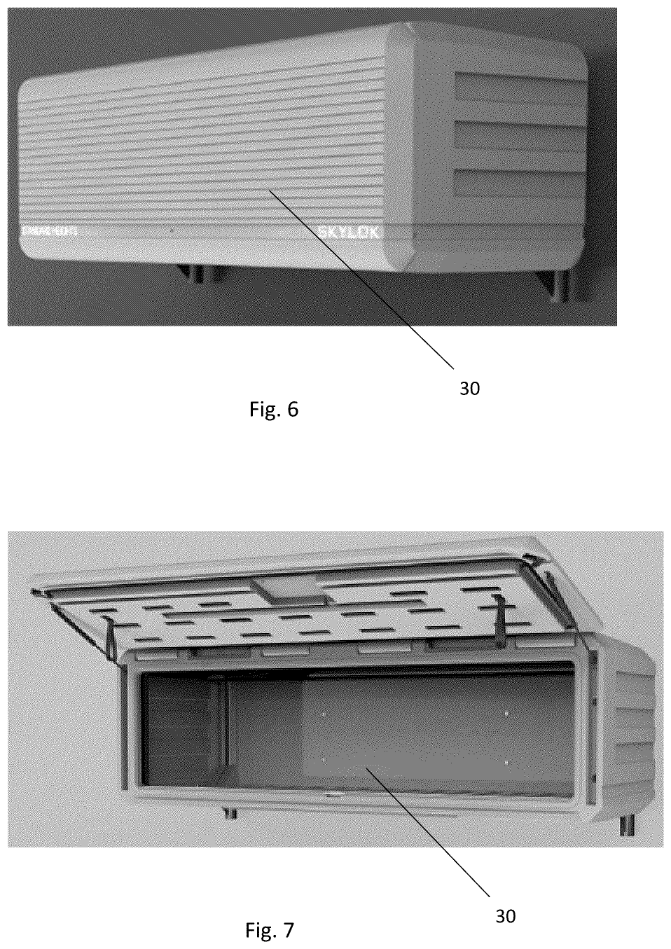

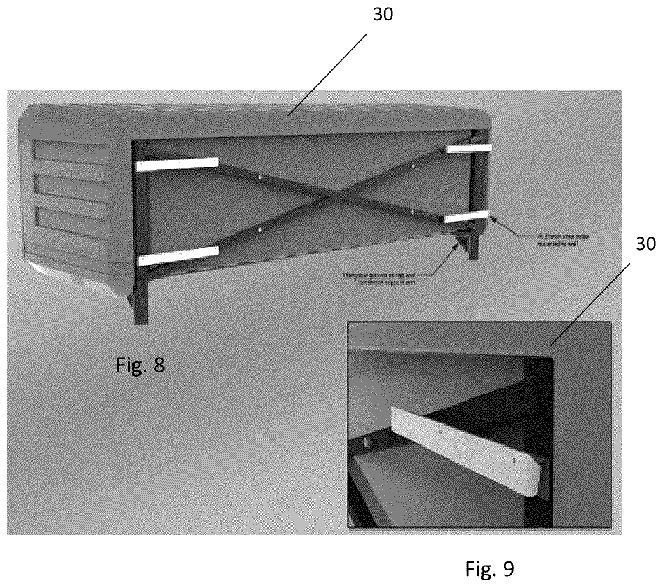

Referring to FIGS. 6 and 7, in an alternative exemplary embodiment, the smart storage container may be in the form of a wall mounted storage container 30. The storage container 30 will have the same features as the storage container 10, but can be fixed or attached to a wall or other mounting surface. As shown in FIGS. 8 and 9, mounting brackets and braces are included on the back side of the storage container 30 to permit the mounting of the container to the wall or mounting surface. The brackets and braces create a modular frame design that is easy to install on-site and also provide additional structural integrity and support for the container itself. In an aspect, the brackets and braces that support the container may provide a universal fit to mount to wall brackets or slide over and fit to support legs for floor standing use, as described below.

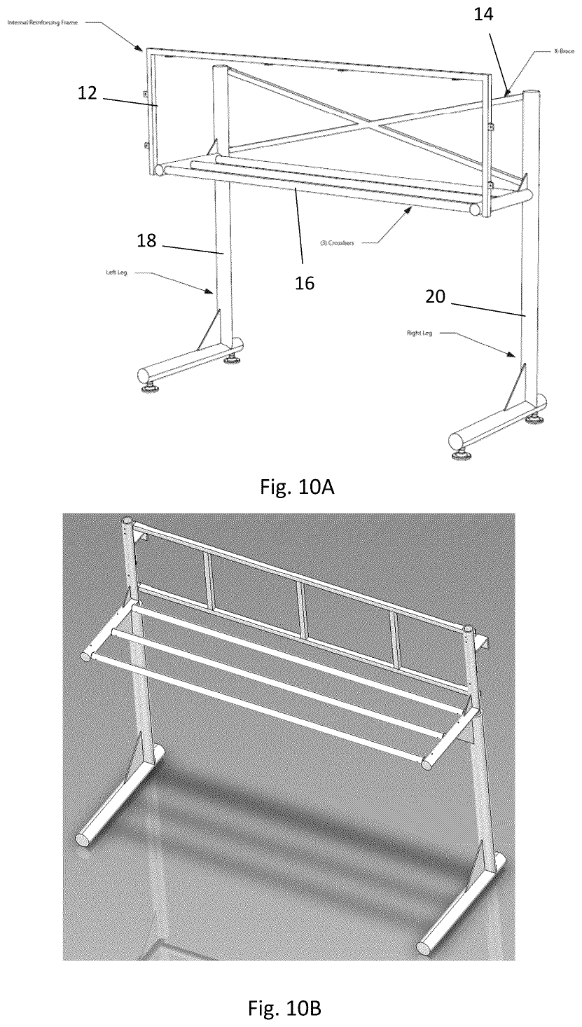

Referring to FIGS. 10A and 10B, in an exemplary aspect, the support frame for the storage container 10 is depicted. In one embodiment, the support frame may include a reinforcing frame 12 that may mount to the enclosure of the container 10. The support may further include a cross-brace reinforcing structure 14 to provide additional support and integrity to the container 10. Crossbars 16 may also be positioned underneath the container to provide support for the container and to join the left support leg 18 to the right support leg 20. The support legs may include adjustable feet to permit the leveling of the container 10. The adjustable feet may be replaced by wheels or rollers to facilitate the ease of movement and relocation of the storage container 10. As shown in FIG. 10B, the support frame may consist of modular components that may be easily shipped to a desired location and then easily assembled on-site at that location. The modular design further allows the support frame to be disassembled and then easily transported to another location for re-assembly.

Referring to FIG. 11, in an exemplary aspect, the support frame for the storage container 30 is depicted. In one aspect, the support frame may include a cross-brace reinforcing structure 32 to provide support and integrity to the container 10 and to serve as a mounting structure to allow the mounting of the container 30 to a wall or mounting surface. Crossbars 34 may also be positioned underneath the container 30 to provide support for the container and to join the left hanging support leg 36 to the right hanging support leg 38.

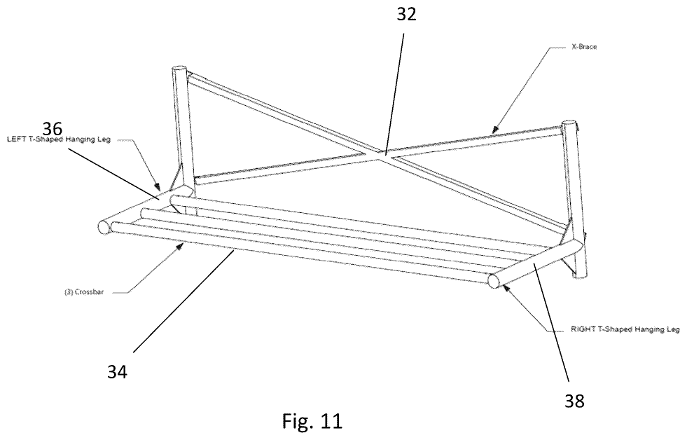

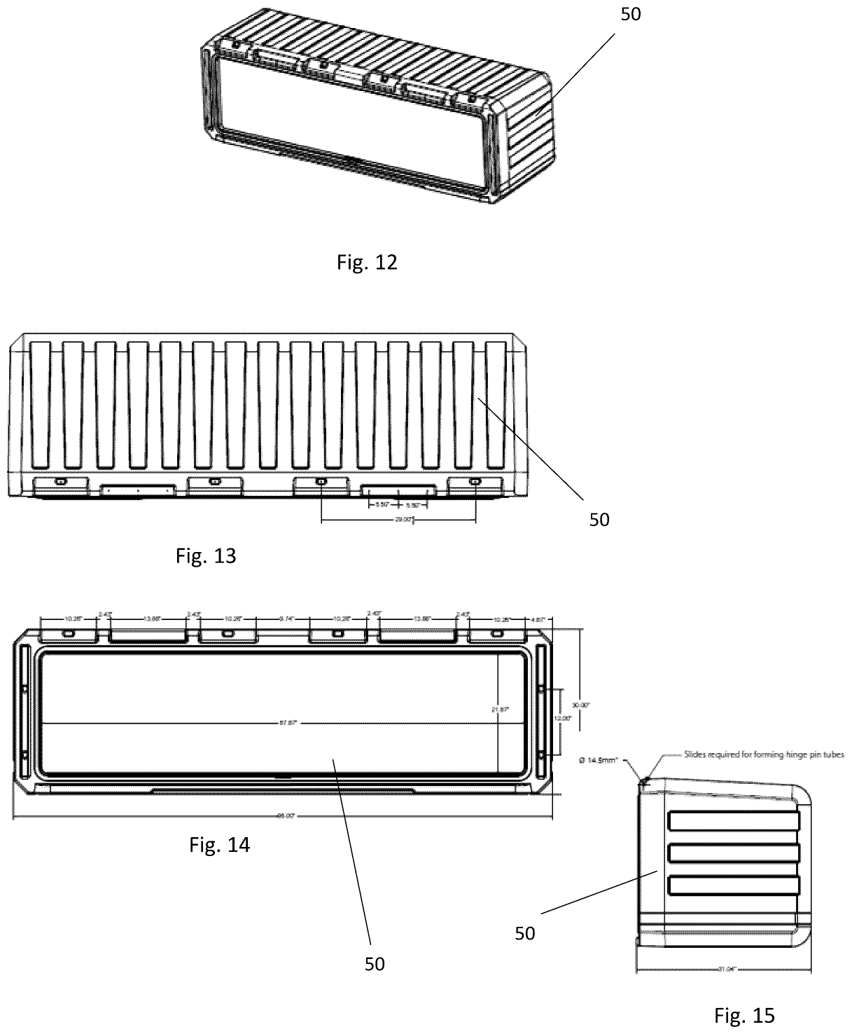

Referring to FIGS. 12-15, there are depicted various views of the storage container enclosure without the door attached. The storage container may be made from a thermoplastic material through a rotomolding process or other suitable process to form a lightweight, strong and wear resistant enclosure. The container may define any one of a number of shapes and configurations and provide numerous possible volumetric capacities. One or more hinges may be located on the top front edge of the enclosure to permit the mounting of the door to the enclosure. One or more seals may be located around the perimeter edge of the enclosure to allow the door to be sealed to the enclosure when the door is moved to the closed position.

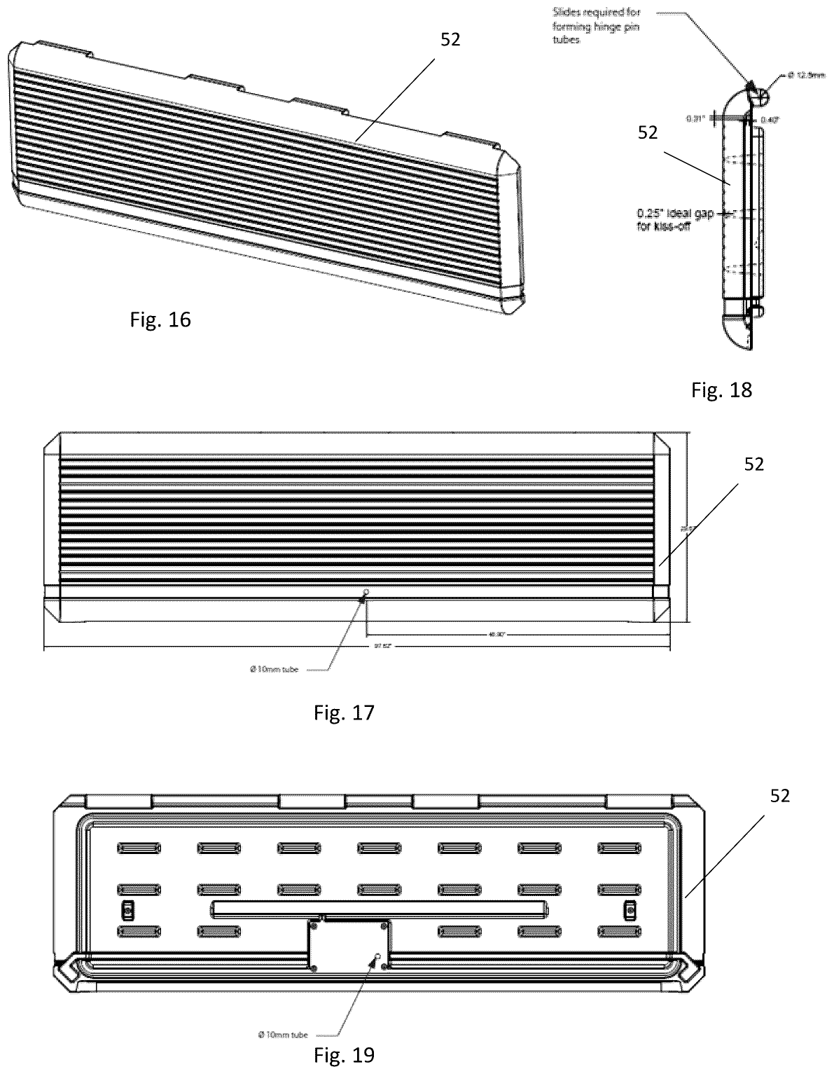

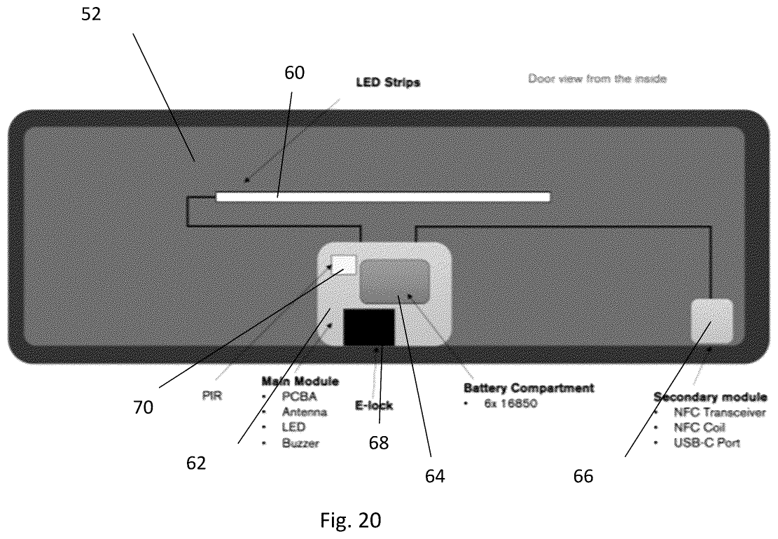

Referring to FIGS. 16-19, there are depicted various views of an exemplary door 52 for use with the storage container enclosure. Like the storage container, the door may be made from a thermoplastic material through a rotomolding process or other suitable process to form a lightweight, strong and wear resistant door. The door may define any one of a number of shapes and configurations. The door at its top edge may be configured to receive a hinge to mount the door to the enclosure. The door is movable and is pivotally attached to an upper edge of the enclosure and extends downwardly to form a closed position that inhibits access to the interior of the enclosure, and is movable to an open position to allow access to the interior of the enclosure. One or more seals may be located around the perimeter edge of the door to allow the door to be sealed to the enclosure when the door is moved to the closed position. As explained below, the door may include a lock and may include electronic componentry used to accomplish the smart locking features of the invention. The door may also include an LED light bar or similar lighting that turns on when the door is in an open position, and may include any number and types of sensors that will provide additional security to the storage container or information about the storage container or its surrounding environment.

Referring to FIG. 20, there is depicted an exemplary schematic view of the inside of the door 52. Attached to the inside of the door may include components to provide the smart lock functionality of the storage containers 10, 30. The location of the components to provide the smart lock functionality of the storage containers may vary. For example, the components to provide the smart lock functionality may be located on an interior wall of the storage container enclosure. In an exemplary aspect, the smart storage container may include a main module 62 for controlling a printed circuit board that contains firmware that controls the smart lock and the wireless communication to and from the storage container. The main module may also include an antenna and supporting circuitry used for sending and receiving wireless signals to and from a mobile device. The main module may further include an LED light bar 60 as well as a sensor, buzzer or sound creating device to alert the user when the door is open. The antenna may be part of any known transceiver system that enables data communication over a wireless medium, whether using Wi-Fi or Bluetooth® protocols for the wireless communication. Still other known types of wireless communication protocols and associated hardware may be used.

A battery compartment 64 may be located near and in communication with the main module 62 to provide battery power to the main module and other components used on and in the smart storage container that might require power. The battery compartment may include a rechargeable battery and associated circuitry to distribute power from the battery to other components in and around the storage container. In an aspect, the battery compartment may include circuitry connected to a power source to charge the battery. In an alternative aspect, the charging may be done wirelessly through an inductive charger. In other aspects, other power sources may be used, such as solar cells that may be used in replace of or in addition to the battery. In an alternative aspect, the main module may control the battery to power it down or place it in hibernation mode when desired to reduce power consumption.

In an exemplary aspect, a secondary module 66 may be used and may include a near field communication transceiver and coil, or RFID protocol and hardware that permits communication with a mobile smart phone, watch or key fob/key chain device to allow tap to open functionality or touchless unlocking, or any other known near field communication protocol and hardware. The storage container may also include a USB port or similar port to permit wired connectivity to the storage container. This port may also permit an interface to provide power to the battery compartment.

In an alternative aspect, one or more storage subsystems may be used with the smart storage container. Exemplary storage subsystems may include by way of illustration use of flash memory, other semiconductor memory, any other non-transitory storage medium, or a combination of media, and it may include volatile and/or non-volatile media. In some embodiments, the exemplary storage subsystem may store various media files, such as audio files, video files, image or artwork files, or information about the user. In one aspect, the storage subsystem may store one or more applications or apps to be executed by a processing subsystem of the main module.

In an aspect, a processing subsystem may be implemented as one or more integrated circuits, such as one or more single-core or multi-core microprocessors or microcontrollers. In operation, the processing subsystem may execute a variety of programs in response to program code and may maintain multiple concurrently executing programs or processes. At any given time, some or all of the programs to be executed may reside in the processing subsystem or in the storage subsystem.

In an alternative aspect, one or more speakers may be used to provide sounds or alerts. The speakers may produce various tones, such as beeping or ringing, or may be used to reproduce or mimic a person's voice.

A smart lock 68 may be used with the storage container. The smart lock may be controllable via a mobile device application. The user mobile device application may provide the option of locking and/or unlocking the smart lock 68. In some examples, the smart lock may be an integrated IoT smart lock that is controllable through Bluetooth® low energy, near field communication, or Wi-Fi signals provided from the mobile device. In an exemplary aspect, each smart lock may have its own key that may be controlled by the administrator on the backend. The backend administrator may key or re-key the lock, if necessary, for a particular storage container. Each user of the storage container may have its own unique key and userid assigned by an administrator. In one aspect, the user keys may be keyed from a master key that may be set up for a particular storage container. Each of the keys may be encrypted by the backend administrator, and may be securely transferred in encrypted form to the user's mobile device application to be used by the user to lock and unlock the storage container via the smart lock 68. Once unlocked, in another exemplary aspect, the user may be able to resent the smart storage container by pressing and holding for a set period of time a system reset button. The storage container will then go into reset mode and will reset back to factory settings.

In an exemplary aspect, the application 20 on the mobile device and its graphic user interface will permit the user to control the smart lock 68 and also any sensors and lights used within or around the container. In an alternative aspect, one or more sensors on the movable door may be used and may communicate with the smart lock 68. The sensors may detect whether the movable door is in the closed position and communicate this position to the smart lock 68 which will trigger the locking mechanism to automatically lock the door.

In one aspect, the user interface may include any combination of input and output features. Examples of input features may include a touch screen, microphone, and/or camera. Examples of output features may include a display and speakers.

In an aspect of the disclosure, one or more sensors 70 may be used to provide additional security for the storage container. The sensors may be any number of types of sensors, including motion sensors, heat sensors, humidity sensors, accelerometers, and passive infrared sensors that may detect motion or heat. In an exemplary aspect, the sensors may continuously monitor the temperature and humidity in and around the storage container.

The sensors may be other types of sensors that provide a means for detecting motion or movement in or around the storage container. In an exemplary embodiment, if the motion sensor detects movement three times within a period of twenty seconds, for example, an alarm may trigger notifying the owner of the storage container of this movement. The sensors may also be light or magnetic sensors. The sensors may also be geo-location sensors that will allow one to determine the location of the storage container. The sensors may provide information on a streaming basis or in response to polling by the user or administrator.

In another aspect, the enclosure may include internal and external LED lighting for illuminating the interior and exterior of the smart storage container and illuminating the surrounding area. In other aspects, cameras or recording devices may also be used with the smart storage container to provide additional monitoring and security for the storage container. The camera may be a compact digital camera that includes an image sensor to focus an image onto the image sensor, along with control logic to use the imaging components to capture and store still and/or video images. Recorded images or video may be stored on a storage subsystem and may be transmitted to a user or administrator.

In another exemplary aspect, as illustrated in exemplary form by FIG. 3, the mobile device application or app may control numerous features of the storage container, including the locking and unlocking of the storage container. The application may have various functionality and operations including, without limitation, the ability to provide via a graphic user interface the status of the lock: whether it is locked or unlocked. It can also identify the location of the lock and thus the storage container, which is useful in situations where the entire storage container is moved to a different location. The application may include a touchscreen display that permits the user to control various settings of the storage container, including controlling what users have access to the lock and what control they may have over the operation of the lock. The application may also be used to do a status check of the storage container, including checking the battery level of the battery used with the container or whether the lights and sensors, for example, are operating properly. In an exemplary aspect, there may be a front-end application used by a user of the smart storage container and a back-end application used by an administrator.

In an exemplary aspect, the front-end application or app may have numerous features to allow the user to control the various features of the smart storage container. Some of the app features allow the user to create an account or to register as a user of the storage container. Once set up, the user may elect to set up two-factor authentication to access the app functions. This may include setting a personal identification number (PIN), setting up facial recognition for those devices that allow for facial recognition, or creating fingerprint recognition, or all of the foregoing.

Upon accessing the app, the user may set up a name for its smart storage container, or rename it if already named. The user may upload an associated photo for the storage container. Once the user is logged into the app, the user may then perform a number of functions. In an exemplary aspect, the user may view the status of the smart lock to determine whether the lock is open or closed. The user may view the location of the smart storage container to help the user locate the container, and the user may share this location with another user. If desired, the user may revoke the previously provided user access or sharing, or may set up an expiration of another's access to the unit through virtual keys. In an alternative aspect, the user may provide one-time access or multi-use access for a set period of time.

Still other features are possible with the front-end user app. In an aspect, the user may set up alert notifications to notify the user if the door is left open, or if it has been left open for a predetermined time. The user may also control the smart lock to unlock it when desired, such as when another person or a delivery service is at the storage container and wants to place something within the container. Once the items are placed within the container, the user may then lock the storage container. The app may also be used to set the storage container to lock automatically within a certain timeframe. The user may set a timer to have the container unlocked for a set number of hours during the day, and to automatically lock in the evening. In another aspect, the app may be used to turn on/off the LED lighting used in or around the storage container. The status of each container may be determined visually by observing LED status lights that are on the door of the container.

The app may also turn on/off one or more sensors that are used in and around the container. The app may also receive status alerts from the storage container, and may push those alerts to the user through a text or instant message. In an aspect, the app may be used to manage or control more than one storage container.

In a further aspect, proximity sensors may be used in and around the storage container to trigger certain automations. In one aspect, the proximity sensors can trigger a smart home system to turn on the lights in the house. This can happen when a car pulls up next to the smart storage container containing the proximity sensor. Signals from the smart storage container may be sent to any number of home system, such as Amazon Alexa®, Apple Home®, Google Home®, or SimpliSafe®, to name a few, which are also controlled through their own smart home app. The proximity sensors or motion sensors upon detecting the presence of a vehicle or person around the storage container may be used to trigger lights to be turned on or off based on the presence or absence of a vehicle or person. In an additional aspect, sound, alerts, or music could be turned on or off depending on whether a vehicle or person is within proximity of the storage container. The communication from the smart phone containing the app to pair to and control the smart storage container may be made via Bluetooth® (within proximity) or through RFID communication via a mobile smart phone, watch or key fob/key chain device (tap to open), through Wi-Fi, or through a cellular service. In addition to the smart phone, the app may be controlled by a smart watch that may be used with the smart phone.

The communication link between the app and the smart storage container may be a direct connection or an indirect connection. If the connection is a short-range connection, Bluetooth® may be used by the app to control the storage container. If the connection is a long-range connection, Wi-Fi or a cellular service may be used by the app to make the connection. The use of Wi-Fi or a cellular service may also permit the user to access or connect with a remote backend app or a remote data storage management system, which may store information about the user or the user's account data. Data from the remote data storage management system may be presented to the user through the app. It will be appreciated that one or more data stores may be stored locally on a mobile device or on a server. In an exemplary aspect, the communication may be asynchronous. For example, if the user is in front of or in close proximity to the storage container, and there is no Wi-Fi or cellular connectivity, the app will connect to the container via Bluetooth® (BLE) to capture data such as battery life, door state, sensor status, among other data. This captured data may then be uploaded to an administrative system or backend system once a user is able to connect via Wi-Fi or cellular service.

In another aspect, other sensors for the storage container may include infrared sensors, ultrasound sensors, radar and vibration sensors, accelerometers, emission detection sensors, sound sensors, ambient light sensors, optical sensors, and heat sensors, to name a few. One or more or all of these sensors may be used with the storage container. These sensors may be used to monitor various aspects of the storage container. For example, the sensors may be used to monitor tampering of the storage container, or the temperature or humidity in or around the container. The sensors may also detect motion within or in the vicinity around the storage container. Emissions sensors may be used to detect the air quality or emissions levels around the storage container and a network of sensors from each of the storage containers may be used to monitor the air quality or emissions within an entire parking structure or garage. The sensors may provide information on a streaming basis or in response to polling by the user or administrator.

In an aspect, the storage container may be equipped with electric vehicle charging units for electric vehicles, such as cars, trucks or bikes. The charging capability may be a separate add-on feature to the storage container, or it may be integrated into the container itself.

In another aspect of the disclosure, a backend application or app may be used that will allow administrators to set up the smart storage container and to invite users to use the smart storage container. In one aspect, the backend app may send open commands to the main module of the smart storage container to set up the system or if the smart storage container was used previously to re-set the system. The smart storage container in turn may send back communications indicating the status of the setup and the overall status of the smart storage container. In one aspect, the backend app may provide an invitation to use the smart storage container via a QR code, text link or email or any other way to provide the invitation. The backend application may have various management controls over each of the smart storage containers. In an aspect, the app may allow management to search for a user (or his or her account) and assign a storage container to that user. Or it may revoke or prohibit use of the container by that user. For example, if the user of the storage container has not paid for the use of the container, the backend app can be used to lock the user out until payment is made.

The backend app may allow one to track the names of the users of the storage containers and retrieve or add information to a management database. It can also be used to identify and locate the physical location of each storage container that is part of one or more networks of containers, and to view and monitor each of the containers and the activity associated with each of the containers.

In another aspect, the backend app may be used to block or allow access to a smart storage container, or provide emergency access, if necessary. It may also clear smart lock information and reset user information and passwords, if necessary. It can also provide other features and controls, such as, it can monitor the status of each container, including the battery life and the operation of the LED lights. It can also monitor the sensors, cameras, alarms, or any other features of the storage container. The backend app may also be used to push update software to each unit so that the unit can update itself. Other features of the backend app are possible to further allow one to manage each of the smart storage containers.

In another aspect, the backend application may provide a comprehensive lock management system that offers an extensive set of features to manage the locks, users, and access the locks. In one aspect, some of the main components of this service may include user management, lock management, configuration, ownership management, location, invitations, events, status check, and validation errors. In an aspect, users can be created, updated, and listed, and managed with attributes such as email, name, phone number, and role. The backend application may support different user types with role enumerations. The backend application may also manage the locks, by adding updating and listing each of the locks. Each of the locks can be managed with attributes like serial number, name, master key, firmware, image, battery level, status, location, and configuration. The backend application may support various lock statuses with status enumerations. The configuration component may be used to manage configurations such as sleep time, sleep from, sleep to, and the time zone. The ownership management allows the assignment and listing of lock ownership. The backend application may support different ownership types with ownership type enumerations. And the lock location management may include location information, including latitude, longitude, and a name associated with the lock. The backend application may also manage invitations sent out, including creating, updating, and listing the invitations, as well as manage the invite attributes, such as the lock ID, type, name, expiration date, accepted flag, and accepted by user ID, to name a few attributes. The backend application may also manage events by listing events generated by the system and may provide event-specific details such as event type, lock ID, user ID, and so forth. The backend application may further perform a health or status check of the systems and the various components of the systems. It may also support different health statuses with status enumerations. The backend application may also manage and handle validation errors and provide detailed error information, including the location, message, and error type detected from the systems.

In an aspect, the lock management system provides a robust solution for managing and monitoring the lock systems, keeping track of user access, and maintaining the security and configuration of locks.

In another aspect, a plurality of smart storage containers may be networked to provide the ability to monitor an entire parking structure or area where the storage containers are being used. The network can provide feedback as to the location of each of the storage containers. It can also provide information as to the temperature and humidity within the parking structure. It can also be used to detect fire or smoke, or the overall air quality within the parking structure. The network can also monitor motion in the parking area and detect potential tampering of one or more of the storage containers.

Through the use of motion or heat sensing or other sensors, the network can determine whether someone is in a certain part of the parking structure without authorization. This detection could then control one or more security cameras to observe the particular area of interest or activate an alarm system. The network can also track when maintenance was performed on a storage container and can be used for predictive maintenance of other containers.

In an exemplary embodiment, a smart storage container system may include an enclosure mounted to a support frame, a movable door mounted to the enclosure to allow access to an interior of the enclosure or to inhibit access to the interior of the enclosure, and an electronic smart lock system operatively connected to the movable door to selectively lock or unlock the door. The electronic smart lock system may also include a main module coupled to the smart storage container for controlling a printed circuit board, an antenna coupled to the printed circuit board for sending and receiving wireless signals to a remote device, an LED light bar coupled to the main module, one or more sensors coupled to the main module, and an electronic lock coupled to the printed circuit board that can lock the movable door relative to the enclosure or unlock the movable door relative to the enclosure. Upon receiving a wireless signal by the antenna that was sent from the remote device, the main module can either lock the electronic lock to prevent movement of the door or will unlock the electronic lock to permit movement of the door to thereby allow access to the interior of the enclosure.

The support frame may include a plurality of L-shaped support legs connected to support cross members, and wherein the enclosure is mounted to the support cross members. The movable door may be pivotally attached to an upper edge of the enclosure and extend downwardly to form a closed position that inhibits access to the interior of the enclosure, and is movable to an open position to allow access to the interior of the enclosure.

The remote device may be a handheld device, such as a mobile phone or tablet, and may include an application stored on the handheld device that also has short range wireless connectivity. The application may control the operation of the smart storage container. The electronic lock may be an integrated IoT smart lock controllable through a Bluetooth low energy signal. The application on the handheld device may provide a graphic user interface that will permit control of the electronic lock through the application.

The smart storage container system may also include a secondary module coupled to the smart storage container that includes a near field communication transceiver and coil for communication with the application on the handheld device. The secondary module may allow touchless unlocking of the electronic lock. The application on the handheld device may also control the LED light bar. The application on the handheld device may also control the locking and unlocking of the electronic lock, and may provide a graphic user interface showing the status of the lock and whether it is in the locked position or the unlocked position. The smart storage container system may further include multiple sensors coupled to the main module. The sensors may include motion sensors to detect movement of the movable door or movement in an area around the smart storage container. The application on the handheld device may provide a graphic user interface showing the status of the LED light bar and the sensors.

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, sub-combinations, and permutations of structure, operations, and/or other features described herein and in the accompanying drawing figures.

Although examples are described above, features and/or steps of those examples may be combined, divided, omitted, rearranged, revised, and/or augmented in any desired manner. Various alterations, modifications, and improvements will, in view of the foregoing disclosure, readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A smart storage container system comprising:
an enclosure mounted to a support frame,
a movable door mounted to the enclosure to allow access to an interior of the enclosure and to inhibit access to the interior of the enclosure,
an electronic smart lock system operatively connected to the movable door to selectively lock or unlock the door, the electronic smart lock system further comprising:
a main module coupled to the smart storage container for controlling a printed circuit board,
an antenna coupled to the printed circuit board for sending and receiving wireless signals to a remote device,
an LED light bar coupled to the main module,
one or more sensors coupled to the main module, and
an electronic lock coupled to the printed circuit board that can lock the movable door relative to the enclosure or unlock the movable door relative to the enclosure,
wherein upon receiving a wireless signal by the antenna that was sent from the remote device, the main module will either lock the electronic lock to prevent movement of the door or will unlock the electronic lock to permit movement of the door to thereby allow access to the interior of the enclosure.

2. The smart storage container system of claim 1, wherein the support frame include a plurality of L-shaped support legs connected to support cross members, and wherein the enclosure is mounted to the support cross members.

3. The smart storage container system of claim 2, wherein the movable door is pivotally attached to an upper edge of the enclosure and extends downwardly to form a closed position that inhibits access to the interior of the enclosure, and is movable to an open position to allow access to the interior of the enclosure.

4. The smart storage container system of claim 1, wherein the remote device is a handheld device, and further comprising an application stored on the handheld device having short range wireless connectivity, wherein the application controls the operation of the smart storage container.

5. The smart storage container system of claim 4, wherein the electronic lock is an integrated IoT smart lock controllable through a Bluetooth low energy signal.

6. The smart storage container system of claim 4, wherein the application on the handheld device provides a graphic user interface that will permit control of the electronic lock through the application.

7. The smart storage container system of claim 4, further comprising a secondary module coupled to the smart storage container that includes a near field communication transceiver and coil for communication with the application on the handheld device.

8. The smart storage container system of claim 7, wherein the secondary module allows touchless unlocking of the electronic lock.

9. The smart storage container system of claim 4, wherein the application on the handheld device controls the LED light bar.

10. The smart storage container system of claim 4, wherein the application on the handheld device controls the locking and unlocking of the electronic lock.

11. The smart storage container system of claim 10, wherein the application on the handheld device provides a graphic user interface showing the status of the lock and whether it is in the locked position or the unlocked position.

12. The smart storage container system of claim 10, wherein the application on the handheld device provides a graphic user interface showing the status of the LED light bar and the sensors.

13. The smart storage container system of claim 10, wherein the one or more sensors are motion sensors to detect movement of the movable door or movement in an area around the smart storage container.
